(19) United States
(12) Patent Application Publication
(10) Pub. No.: US 2003/0127763 A1
(43) Pub. Date: Jul. 10, 2003

(54) Mechanically glued board of wood material

(76) Inventor: Josef Stutz, Nicosia (DE)

Correspondence Address: PEARNE & GORDON LLP, 526 SUPERIOR AVENUE EAST, SUITE 1200, CLEVELAND, OH, 44114-1484, US

(21) Appl. No.: 10/182,249

(22) PCT Filed: Aug. 16, 2001
(86) PCT No.: PCT/EP01/09472

(51) Int. Cl. B27N 3/08

(52) U.S. Cl. 264/40.4; 264/109; 264/122; 425/204

(57) ABSTRACT

The invention relates to a method of manufacture as well as associated apparatus for a board made of fibres or chip as well as a board made by the method. The invention relates in particular to MDF- or HDF- or chip boards.

The aim of the invention is the provision of a board with a smaller proportion of glue in comparison with the state of the art.

To solve the problem of the invention the fibres or chips are in particular first dried and then glue is mixed with the dried fibres or chips at temperatures lying substantially below the drying temperatures and in fact in particular below 100° C. In this way one avoids the glue being undesirably exposed to the relatively high temperatures which arise during the drying.

The result is a board having a relatively low proportion of glue.

The invention relates to a method of manufacture as well as associated apparatus for a board made of fibres or wood chips, as well as a board produced according to the method. The invention relates in particular to MDF- or HDF- or chip-boards.

A typical known method of production for the manufacture of a board of the kind stated in the introduction is performed as follows. Boiled wood shavings for the production of the board made of fibres are first fed to a so-called refiner. In the refiner the wood shavings are reduced to fibres and in fact under the application of heat and pressure with the aid of milling discs. From the refiner the fibres are extracted using steam and conducted through a pipe known as a “Blue-line”. In this arrangement the steam pressure amounts to about 10 bar. The temperature lies at about 150 to 160°. Glue is added in to the “Blue-line”. Following the addition of the glue the “Blue-line” broadens out. Turbulence is caused by the broadening. The glue mixes with the fibres. The proportion of the glue is about 22% by weight in relation to the fibres.

The “Blue-line” opens out into the middle of a drying tube. The drying tube has a diameter of e.g. 2.60 m. Air is blown through the drying tube at a temperature of 160° C., up 220 to 240° C. maximum. The moisture content is reduced in the drying tube from 100% to 8 to 11%.

In particular in the drying tube the glue is exposed in a unwanted manner to the effect of heat. From above about 80° glue is adversely affected or activated. Activated glue is no longer capable of use for the subsequent treatment step, in which the glued fibres are pressed to form the board.

The active part of the glue is reduced by the above-mentioned state of the art. Of the original 22% by weight only around 1 to 8% by weight is still capable of use in the stated state of the art, when the fibre-glue mixture leaves the drying tube.

In HDF-, MDF-boards and also in chipboards a glue based on a urea formaldehyde resin is currently used. Where boards are made for flooring, melanin is added to the glue. This aims to prevent the swelling which can arise as a result of damp.

The problem to solve is therefore that some of the glue is lost to the actual process step as a result of the effect of heat. A drawback is also that substantially more glue must be added to the fibres or the chips than is necessary in order to press the fibres or the chips in a process with the application of heat and thereby to obtain the desired result, namely to produce MDF-boards. Currently an MDF board has around 60 kg of glue per m³.

It is the aim of the invention to provide a board having a lower proportion of glue in comparison with the state of the art.

The aim of the invention is met by a method having the features of the main claim as well as by equipment for carrying out the method and having the features of the auxiliary claim. The result is a board having the features of the further auxiliary claim. Preferred embodiments are revealed by the subsidiary claims.

To solve the problem of the invention the fibres or chips are in particular first dried and then glue is mixed with the dried fibres or chips at temperatures which lie substantially below the drying temperatures and in fact in particular below 100° C. In this way one avoids the glue being exposed in an unwanted manner to the relatively high temperatures which arise during drying.

Furthermore the advantage is achieved that in the drier or drying tube only water, but no chemicals are dried. Environmental advantages are obtained from this as the drying air is not disadvantageously loaded with vapours, which in the state of the art originate from the glue.

The fibres or chips which are dried are preferably not coated with glue. Glue “disturbs” the drying process. Therefore in the drier, in comparison with the state of the art, substantial quantities of energy are also saved, which otherwise must be introduced for the drying. Significant advantages in cost are the consequence.

By the gluing process according to the invention, in the field of MDF boards the quantity of the glue required is reduced. A reduction to 45 to 55 kg per m³ of board is achieved. A typical value lies at 50 to 52 kg per m³ of board.

An important quantity for obtaining the appropriate gluing of fibres or chips is the “correct” ratio of fibres or chips to glue. According to the invention, therefore, in one embodiment of the method the dried fibres or chips are fed to a weighing conveyor. On the weighing conveyor the fibres or chips on the one hand are transported by means of a moving conveyor belt and on the other hand they are weighed. In this way information is obtained on what quantity of glue needs to be added to the fibres in the subsequent step.

The fibres or chips which are supplied are carried by the weighing conveyor to the next device. Possible variations in weight of these fibres which are so fed are detected during transport, registered and stored in one embodiment. This data is processed and serves as setting magnitudes for the subsequent gluing step. In one embodiment this regulation also takes into account the travelling time of the material which passes between the point of measurement and the moment of reaching the subsequent equipment, such as for example drawing-in rollers. In this way it is ensured that the alteration in the drawing-in speed also follows the actual variation in weight.

By alteration of the drawing-in speed a constant quantity of material is supplied to the subsequent devices. The determination of the weight of the fibres or the chips can take place in fine steps and makes possible a uniform feed of the fibres or the chips with an accuracy of, for example, ±1%.

It is not easy to provide fibres with sufficient glue, as fibres are inclined to bunch together like cotton wool. It is then difficult to distribute the glue uniformly on the fibres. Therefore, in one embodiment of the invention the gluing takes place in a mixer, in which the glue and fibres are mixed together. The use of the mixer offers comparable advantages in the case of chips.

In one embodiment of the invention the mixer has means for cooling its housing. For this purpose, in one particularly simple embodiment, a housing which is at least partially double-walled is provided, for example a double-walled tube which is part of the housing of the mixer. A cooled fluid, for example cooled water, is conducted through the double-walled housing in order to cool the mixer, or rather its walls. A layer of condensed water is intended to arise on the walls inside as a result of the cooling. The cooling is designed accordingly. The layer of condensed water has the result that glued as well as unglued chips do not remain adhering to the walls and block the mixer.

In one embodiment of the invention, after the drying of the fibres they are spread out flat and so a kind of curtain is formed of the fibres. Glue is subsequently added and in particular sprayed onto the curtain. Preferably an air-glue mixture is sprayed in order to achieve as a uniform as possible distribution of the glue. By the formation of a curtain the result is achieved that the glue is distributed uniformly on the fibres in comparison with the case in which the fibres are present in lumps.

In a further embodiment of the invention the fibres are introduced into the mixer in the form of a curtain or a mat. The curtain or mat has an air-glue mixture blown onto it through nozzles. The glue is therefore fed to the curtain through the nozzles. The curtain is subsequently preferably conducted through the mixer without contact. Adhesion of fibres to the walls is advantageously avoided by the contactless feed. Contamination problems and the costs associated with them are thereby reduced.

The glue is blown into the dried fibres together with air, in particular at a temperature of 40 to 70° C., preferably at a temperature of 55 to 60° C. In this way the result is achieved that the glue reaches a dry external skin. It is therefore activated to a minimum extent. Hereby the result is better achieved that the subsequent glue-fibre mixture does not remain adhering to the conveying devices and equipment, for example to the interior of the mixer.

In one embodiment of the invention the glue is prepared so that it cures after a predetermined time. Thus the glue can be set suitably by the application of heat. Furthermore a hardener can be included or added, curing after e.g. 60 seconds. The preparation of the glue is carried out in particular in the mixer, or a hardener together with the glue is added to the dried fibres immediately before the mixer.

The advantage is achieved that on the subsequent pressing of the fibres to form a board the glue immediately rapidly sets. In this way short press times can be achieved. In the respective individual case the instant of curing is deliberately set by the expert in the art in order to achieve particularly short press times. This represents a further important economic advantage over the state of the art, in which these short press times could not be achieved because of the curing times of the glue which were needed.

As the glue is exposed to substantially lower temperatures than hitherto, it is possible to introduce more reactive glues in comparison with the state of the art. Furthermore it is possible to reduce the proportion of chemicals such as for example formaldehyde. This results in further environmental advantages.

In one embodiment of the invention the glue is stirred up using heated air and this air-glue mixture is fed to the dried fibres or chips. The hot air, which is for example fed to the mixer through a container together with the glue and the dried fibres, activates the surfaces of the resulting droplets of glue. In this way adhesion of fibres or chips to subsequent devices, for example to the walls of the mixer, is appropriately countered. Otherwise the mixer would need to be cleaned after a very short time, for example. The production would then have to be halted, which is a disadvantage. Furthermore unwanted cleaning costs are correspondingly reduced. These significant economic drawbacks are to be weighed against drawbacks that the glue is activated a little and they have to be compared with one another. By performing a few experiments the expert in the art can determine to what extent the surface of the glue can be activated, in order to arrive at optimum economic results. The proportion of activated glue will always be small in comparison with the state of the art.

In one embodiment of the invention, after the addition of the glue to the dried fibres or chips the free surface of the glue is somewhat further activated by a device suitable for the purpose, in order thereby to simplify the further treatment steps. After the addition of the glue to the dried fibres or chips, in particular after leaving the mixer, the fibres or chips coated with glue are accordingly preferably passed into a rising tube, which is in particular 10 to 30 m, preferably about 20 m, long. The diameter of the rising tube is in particular around 1 to 4 metres.

The rising tube is preferably likewise cooled and in its turn then for example has double walls, in order to allow the passage of a cooling fluid between the two walls of a double wall. The aim is again the formation of a layer of condensed water on the inner walls of the rising tube so that the glue-coated fibres or chips do not remain adhering to the walls.

The glue-coated fibres or chips can be conducted through the rising tube in a particularly simple contactless manner by a stream of air or gas.

It has been found that the fibres or chips should be conducted through the rising tube at a speed of at least 25 m/sec, preferably of at least 35 metres per second. If the speed is lower, fibres or chips remain adhering significantly to the rising tube despite the above-mentioned measures. The rising tube is thereby unnecessarily rapidly contaminated. When lower speeds have been provided, the rising tube had to be cleaned already after 8 hours. By setting of an appropriate speed the cycle can be extended to 7 to 8 days. Therefore the rising tube needs to be cleaned only once a week.

The maximum speed with which the gluecoated fibres or chips are blown through the rising tube depends on the capacity of the following components and devices. In this connection care must be taken that the following components or devices must be in a position to handle the incoming quantity of fibres or chips. In practice at the present time an upper limit of 40 metres per second could be achieved without difficulty. Beyond 50 metres per second the following components used up to now were overloaded. It will be evident that the upper speed limit can be increased as soon as following components of higher performance are available. Basically it is true that higher transport speeds in the rising tube are an advantage, as then problems of contamination and resulting halting of production are correspondingly reduced.

By the provision of the rising tube the result is achieved that the surface of the glue is somewhat further activated in order to be able to perform suitably the succeeding processing steps. The length of the rising tube is therefore matched by the expert in the art to the desired degree of activation of the glue. In designing the layout the expert will take into account the transport speed in the rising tube.

Following the addition of glue to the dried fibres or chips, in particular following the partial activation of the glue in the rising tube the fibres, coated with glue, pass to a cyclone. Here the surface of the glue has now been sufficiently activated on the basis of the measures mentioned above, so that it no longer remains adhering in the cyclone. In the cyclone the fibres or chips are precipitated out and fed to the next treatment step by transport means such as a conveyor belt. The fibres or chips are separated from the air in the cyclone. The transport means in one embodiment conduct the fibres or chips to an inspection station. In the inspection station the fibres are checked for coarse particles. The coarse particles are automatically sorted out. Coarse particles are for example lumps of glue.

From the inspection station the fibres or chips are transported further by means of a conveyor belt to the press and here pressed together to form the board. The press preferably comprises moving pressing bands, suitably tempered, which are pressed together. Thus the pressing can take place continuously. The temperature is matched by the expert to the glue currently being used. The quantity of energy and the resulting temperatures for the two pressing bands are accordingly chosen differently in one embodiment, in order thereby to avoid distortion of the board which is produced. The temperature difference amounts straight away to 20° at pressing temperatures lying around 200° C.

The nozzles through which the glue is fed to the fibres in one embodiment of the invention are preferably of conical shape. The glue emerges through the tips of the cones in droplets, so that thereby a uniform distribution of the glue is advantageously obtained, and therefore improved.

It is of advantage to avoid cleaning operations and a consequent repeated halting of production, if the glue for example emerging from the nozzles does not contact subsequent tools, thus for example the tools present in the mixer. The glue is accordingly preferably directed straight towards the fibres or chips for example, therefore for example sprayed. Furthermore particular attention should then be paid to a sufficient spacing between nozzles and following tools in a mixer. In practice it has been found that the space between tools in the mixer and the nozzles should amount to at least 1 metre, preferably at least 2 metres, when the glue is sprayed in horizontally. The fibres are then introduced perpendicularly at the start of the mixer and transported further in it in a horizontal direction. The stated firm spacing values naturally relate only to one concrete individual example. They are not generally true as it also depends on the speed with which the glue emerges from the nozzles.

If a glue-air mixture is sprayed towards the fibres, preferably at the same time an air stream is available by which the fibres are in addition blown through following devices such as a mixer or a rising tube and thereby transported initially as far as possible without contact. Basically, instead of air a gas could also be used.

In particular stirring devices are used as tools in a mixer, by which mixing of the fibres with the glue is achieved.

In order to obtain good results, the fibres pass in front of the nozzles in the form of a curtain. Thereby, in addition to the advantages already mentioned, one avoids the glue being sprayed into the mixer and tools there being contaminated. Otherwise the fibres would stick to the tools and the mixer would be brought to a halt in a very short time and would have to be cleaned at frequent intervals.

In one embodiment the tools in the mixer are attached to a centrally mounted spindle and comprise rods extending away in a star pattern, each merging into a flat portion like the blade of an oar. Overall a star pattern is made up for example of four tools. Each adjacent pair of tools make an included angle of 90°. In relation to the air stream which passes through the mixer, the oar blades are set at an inclination. This results in turbulence of the air and thereby a thorough mixing of the fibres or chips with the glue. A number of “stars” formed by tools are attached to the spindle, at uniform spacings. The fibres or chips are then transported through the mixer parallel to the spindle. Quite generally the tools are therefore arranged in particular so that the air is made turbulent as well as the fibres or chips. Therefore tools acting as propellers or propeller-like tools are to be preferred.

A curtain is preferably formed from the fibres as follows.

The transport medium, for example a conveyor belt or a weighing conveyor is provided at the end with at least one, and preferably several, rollers. The fibres are fed through the roller or rollers. The rollers are in particular pressed against one another. If a gap remains between two rollers or between the roller and a bounding surface, this basically causes no harm. In this way the result is achieved that a kind of curtain or mat is formed from the fibres by the rollers. Therefore the curtain shape is produced by the rollers.

In this arrangement preferably a conveyor belt is used as this achieves a uniform feeding of fibres to the rollers. If a weighing conveyor is used, then in one embodiment the speed of feeding to the rollers is controlled so that a particularly uniform quantity of fibres is fed to the rollers. According to the state of the art usually screw conveyors are used for feeding fibres in the manufacture MDF boards. However fibres generally leave screw conveyors relatively non-uniformly. A correspondingly non-uniform curtain formed from the fibres would be the result. A curtain of uniforms thickness and width is of advantage in order to achieve a uniform distribution of the glue. Furthermore the result is achieved that the curtain effectively separates the sprayed-in glue from the tools which follow.

In particular, by using the (pressed together) rollers for producing the curtain one avoids the fibres being fed in a wad-like or lumpy form. This would prevent the desired uniform gluing.

In order to be able to process a sufficiently large quantity of fibres to form a curtain as well as in order to achieve a particularly uniform curtain, in one embodiment more than two rollers are employed, through which the fibres are guided to produce a curtain. The rollers are preferably arranged over one another, offset in such a way that an acute angle is included between the rollers and a transport medium, for example a conveyor belt or a weighing conveyor. In this way sufficient material can be fed to the transport medium, i.e. for example delivered to the weighing conveyor, in order to be able to handle uniformly a sufficiently large quantity of fibres.

In practice it has so far been found that four rollers in total are particularly advantageous in order to produce from the fibres a curtain which is subsequently mechanically glued.

In one embodiment the opening, through which the curtain made of fibres is introduced into or ahead of the mixer, preferably corresponds to the maximum width of the mixer housing, therefore for example the diameter of the said tube, which simultaneously forms the walls of the mixer. In this way it is ensured that the whole width in the mixer is covered by the curtain. Otherwise glue could be sprayed through the remaining gaps at the sides, past the curtain and into the interior of the mixer, and the above-mentioned contamination problems would arise.

If the whole width of the mixer were not covered, not only would glue be sprayed into the mixer, but also heavy peripheral fibres would be carried along and form lumps. This would adversely affect the quality of the material. Corresponding production problems and post-treatment of the material would have to be performed, at substantial cost.

In practice the side walls of the mixer are preferably cooled to 7 to 15° C., in particular to 10 to 12° C. In this way the result is achieved that a coating of condensed water is deposited on the walls. Adhesion is prevented by the layer of condensed water.

The cited temperatures are also suitable for the formation of a layer of condensed water on the inside walls within the rising tube.

In a further embodiment of the invention initially wood chips or wood shavings are broken down into the solid wood component cellulose and the liquid components lignin and liquid hemicellulose. Lignin and hemicellulose are separated from the solid components and used as glue, thus according to the invention mixed with the dried wood fibres or wood chips. The solid wood components are further processed to form fibres or chips. The liquid components could for example be separated from the solid components in a so-called agitator. The above-mentioned components which are obtained lie typically at 20 to 35% by weight hemicellulose, 45 to 50% by weight cellulose and 20 to 35% by weight lignin.

In one embodiment wood shavings are first introduced into a plug screw. From the plug screw the wood shavings pass in a compressed state into a boiler and here they are boiled at high pressure. The boiler is designed to handle high pressures. The pressure in the boiler amounts in particular to at least 12 to 22 bar. According to the state of the art wood shavings are as a rule boiled at pressures of only 8 to 9 bar. As a result of the heated steam treatment the solid wood components (cellulose) are separated from the lignin and hemicellulose, which represent the liquid parts. The cellulose is present in solid form. The two other components lignin and hemicellulose are liquid and can basically be used as a glue. The adhesive force in this use is predominantly achieved by the hemicellulose.

It is true that it is known from the printed publication WO 98/37147 to separate the lignin and hemicellulose contained in the wood/from the solid components and use them subsequently as glue in the manufacture of MDF boards. A drawback in this process is the occurrence of substantial emission, which would have been imposed to a degree on the surroundings of a production factory. The development of emission could not be overcome using economically practical measures. According to the invention the problem of the generation of emission is reduced in that the liquid components are initially present in the pressure-tight sealed boiler, from which no parts can escape. After the separation of the liquid components these are cooled down and are processed further at relatively low temperatures, in particular being sprayed onto the fibres through nozzles. The liquid components are therefore substantially cooled down before they leave the smell-tight sealed system. In this relatively cool state the development of smells is very slight. The use of lignin and hemicellulose as glue is therefore made possible in that these components of a wood material only leave a smell-tight sealed system at low temperatures, in particular temperatures well below 100° C. and are applied to the fibres in this cool state. In this way therefore the imposition on the environment of the development of smells is successfully sufficiently greatly reduced in an economical manner.

In one embodiment of the invention the liquid components hemicellulose as well as lignin, obtained in the manner described above, are mixed with conventional glue. The proportion of hemicellulose as well as lignin in the glue mixture preferably amounts to no more than 20% by weight. The mixture furthermore contains in particular a glue based on urea formaldehyde.

If a glue mixture is used containing more than 20% by weight of hemicellulose and lignin, the pressing time (in a backing-up use of the currently conventionally available synthetic glues) is too long, during which the glued fibres are pressed to form a board. It is therefore more economical to mix hemicellulose and lignin with other glues or glue mixtures. In this way on one hand a saving can be made in conventional glue and on the other hand the process is not made too long and thereby uneconomic because of longer pressing times. The question of what upper limit is economically appropriate for the proportion of hemicellulose and lignin naturally depends on the reactivity of the glue, with which the hemicellulose and lignin components are mixed. Accordingly the stated upper limit of 20% by weight simply represents an indication based on experience.

Since air among other things is provided for transporting the fibres with the glue through the mixer, the nozzles for feeding in glue are, in one embodiment of the invention, spaced away from the housing of the mixer. The nozzles are then present in front of an opening in the housing of the mixer. A gap or annular gap thereby remains between nozzles and opening, through which outside air can be drawn in and thereby conveniently introduced. Furthermore in this embodiment the air which is introduced through the gap or annular gap can be pre-heated in order to provide a desired temperature in the mixer, in particular in order thereby to achieve activation of the surface of the glue.

In one embodiment tools are mounted on a spindle inside the mixer. The nozzles for feeding in the glue are then arranged in a ring around the spindle, so that in this way the fibres are uniformly coated with glue. The fibres, or rather the curtain which is made up of fibres, is then preferably introduced between nozzles and tools perpendicular to the spindle. Depending on the diameter of the mixer, nozzles are arranged in a ring in one or more rows. With a corresponding large diameter the entire opening of the mixer is sprayed with glue, in that a second row of nozzles is arranged in a ring around the spindle.

In one embodiment of the invention additional glass fibres or synthetic resin fibres are added to the fibres made of solid wood components. The addition takes place in particular in or directly ahead of the mixer. In this way particularly good board-like shaped bodies can be produced, provided for example as inside trim in a motor vehicle. Such shaped boards can be employed in the motor industry for example as hood linings. It is then sufficient simply to pre-press the laminate system. A final pressing step does not have to be performed.

In the motor industry not so many shaped components are required, as fibres are usually produced economically on a large industrial scale. Accordingly it is more economical to produce shaped components, which are used in particular in the motor industry, simultaneously together with MDF boards (provided for the production of panels), in order thereby to be able to use the quantities of fibres on a mass-production scale. The MDF boards provided for the production of panels have an upper face and a lower face, which run parallel to one another and which are flat. These boards are a few millimetres thick. As a rule they do not have any synthetic resin or glass fibres, as no special shapes need to be made, departing from a flat surface.

In the manufacture of shaped components sharp edges are a problem. These tend to tear. By the reinforcement with glass fibre or synthetic resin fibres these problems can be avoided.

Shaped parts of the above-mentioned kind are also used in the furniture industry. Such shaped components are required for example in doors, which are specially shaped for design reasons.

Differing from boards made of fibres, therefore for example MDF boards, which are provided for the production of panels, in the case of shaped components it is sufficient simply to pre-press them. The pre-pressing takes place at substantially lower pressures than the actual pressing step. The pre-pressing pressure can amount to only ⅓ of the pressure used for the actual pressing step. The actual pressing step can be performed at pressures of 75 to 80 kg/cm².

The proportion of glass fibres and/or synthetic resin fibres in a shaped component amounts to up to 25% by weight, preferably up to 15% by weight, in order to achieve cost-favourable results. At least 5% by weight should be used.

To divert fibres for the manufacture of shaped components from the fibres used for the manufacture of MDF or HDF boards for panels, in particular for flooring panels, is, independent of the fibres mentioned here according to the invention, also especially economical in comparison with the state of the art.

The invention is further clarified in conjunction with the following drawings.

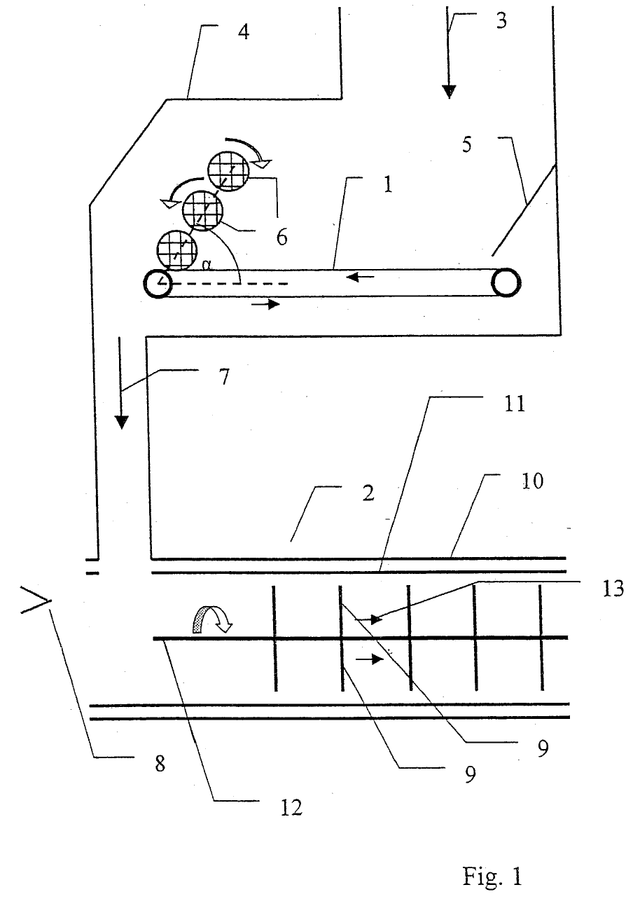

FIG. 1 shows a section through a weighing conveyor 1 and a following mixer 2. As indicated by the arrow 3, dried fibres, produced from wood shavings, are fed to the weighing conveyor 1 through an opening in a housing 4. A ramp 5 guides the incoming fibres onto the belt of the weighing conveyor. The weighing conveyor detects and controls the quantity of material which is transported towards the three rollers 6. The three rollers 6 are arranged one above another and offset, so that they make an acute angle a with the weighing conveyor 1. The fibres present on the weighing conveyor enter this acute angle. They pass through the rotating rollers 6. In this arrangement a curtain is formed from the fibres, and as a result of gravity it is transported further vertically downwards along the path of the arrow 7. The curtain thus reaches and enters the mixer 2 and in fact between a number of nozzles 8 and tools 9.

The mixer has a tubular housing. The housing is formed by a double wall 10 and 11. Mounted centrally inside the housing is a spindle 12 on which the tools 9 are secured. A tool 9 makes a right angle with the spindle 12. Four oar-like tools 9 are combined to form a star. A number of these combined tools are secured on the spindle 12 at uniform spacings. The forward region, into which the curtain made of fibres is introduced, is free of tools. In this way the result is achieved that a sufficiently large space is present between the tools 9 and the nozzles 8. This spacing is provided so that glue emerging from the nozzles 8 does not strike the tools directly during operation.

The diameter of the housing of the mixer corresponds to the width of the opening through which the curtain made of fibres is introduced into the mixer. The width of the curtain is matched to the width of the opening. The nozzles 8 are arranged in a semicircle around the spindle 12 in an upper region. In this way the result is achieved that on the one hand the curtain is uniformly provided with glue and on the other hand the glue emerging from the nozzles 8 does not strike directly against parts of the mixer. A spacing is provided between the nozzles 8 and the housing 10, 11, so that a kind of annular gap is formed. Air is drawn in through this annular gap. Not shown are means for heating the air which is drawn in. In this way a glue-air mixture is formed. The curtain provided with glue (in other words a mat formed of fibres) is transported through the mixer 2 by the air stream parallel to the spindle 12. The spindle rotates during the transport and accordingly so do the tools. 9. In this way the glue is further mixed with the fibres. A cooled fluid is introduced between the two walls 10 and 11 of the double wall, in order to cause a layer of condensed water to result inside the mixer on its inside walls.

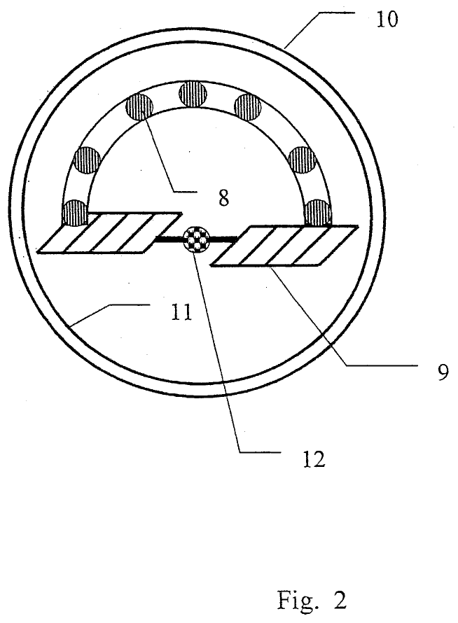

Shown in FIG. 2 is a view of the mixer looking parallel to the spindle 12. For reasons of clarity only two tools 9 are shown. A single-row semicircular arrangement of the nozzles in the upper region is clearly shown in particular in conjunction with FIG. 2.

1. Method for the manufacture of a board made from fibres or chips with the steps:
application of glue to fibres or chips at a temperature below 100° C.,
pressing of the fibres or chips provided with the glue to form a board at temperatures above 140° C.

2. Method for the manufacture of a board made from fibres or chips with the steps:
drying of fibres or chips in a drying device,
application of glue to the dried fibres outside the drying device at a reduced temperature,
pressing of the fibres provided with the glue to form a board in particular with the application of heat.

3. Method according to one of the foregoing claims, characterised in that glue is applied to the fibres or chips, in that a glue-gas mixture is sprayed onto the fibres.

4. Method according to one of the foregoing claims, characterised in that glue is applied in such quantity that 45 to 55 kg of the glue is used per m³ of board.

5. Method according to one of the foregoing claims, characterised in that the fibres or chips are put onto a weighing conveyor before the application of glue and the weighing conveyor and the application of the glue are controlled so that the quantity ratio between the glue and the fibres or chips during the application of the glue is substantially constant.

6. Method according to one of the foregoing claims, characterised in that the fibres or chips provided with glue are mixed together and/or stirred and in fact in particular in a mixer having cooled walls.

7. Method according to one of the foregoing claims, characterised in that the fibres are formed into a curtain or a mat and the glue is applied to the curtain or the mat or introduced into the curtain or into the mat.

8. Method according to one of the foregoing claims, characterised in that the glue together with heated air is applied to the fibres or chips and in fact in particular at an air temperature of 40 to 70° C.

9. Method according to one of the foregoing claims, characterised in that the glue is applied to the fibres or chips together with a hardener.

10. Method according to one of the foregoing claims, characterised in that after being applied to the fibres or chips the glue is activated to an extent limited only to its surface.

11. Method according to one of the foregoing claims, characterised in that the fibres or chips provided with glue are blown through a rising tube.

12. Method according to one of the foregoing claims, characterised in that wood is broken down into solid components and liquid components, and liquid components are applied to the fibres or chips as glue.

13. Method according to the preceding claim, characterised in that the liquid components are cooled down before being applied.

14. Method according to one of the foregoing claims, characterised in that lignin and hemicellulose are contained in the glue and in fact in particular in a proportion of up to 20% by weight.

15. Method according to one of the foregoing claims, characterised in that synthetic resin fibres and/or glass fibres are added to the fibres made of wood.

16. Method according to one of the foregoing claims, characterised in that board-like shaped bodies are produced.

17. Method in particular according to one of the foregoing claims, characterised in that MDF- and/HDF-boards for flooring panels and shaped bodies are produced at the same time and the fibres used for these purposes originate from the same device, in particular from the same milling device.

18. Apparatus for the manufacture of a board prepared from fibres or chips with a drying device in which the fibres or chips are dried, and with a glue-applying device, in which the fibres or chips are provided with glue, and with means for pressing the glued fibres or chips to form a board,
characterised in that
transport means (1,7) are provided, by which the fibres or chips are transported from the drying device to the glue-applying device (2, 8).

19. Apparatus according to the foregoing apparatus claim with a device in which wood shavings are reduced to fibres and in fact in particular with the aid of heat and pressure and with the aid of milling discs.

20. Apparatus according to one of the foregoing apparatus claims, in which the drying device has a tube together with means by which a gaseous medium is heated and blown through the tube.

21. Apparatus according to one of the foregoing apparatus claims, in which the transport means include a weighing conveyor (1).

22. Apparatus according to one of the foregoing apparatus claims, in the which a mixer (2) is provided, in which glue and fibres or chips are mixed together and in fact in particular mechanically by means of stirring tools (9), the stirring tools preferably being arranged like the blades of oars and like propellers, in order thereby to be able to cause turbulence of air in the mixer.

23. Apparatus according to one of the foregoing apparatus claims, in which a mixer (2) together with means for cooling its housing (10, 11) is provided.

24. Apparatus according to one of the foergoing apparatus claims, in which a mixer (2) is provided, having at least partially a double-walled housing (10, 11) in fact in particular a double-walled tube.

25. Apparatus according to one of the foregoing apparatus claims, in which cooling means are provided for cooling a fluid, as well as means for cooling with the cooled fluid the housing of a mixer and/or of a rising tube.

26. Apparatus and according to one of the foregoing apparatus claims, with means for producing a layer of condensed water on the inside walls of a mixer and/or of a rising tube.

27. Apparatus according to one of the foregoing apparatus claims, with means (6) for feeding the fibres to the glue-applying device in the form of a curtain or a mat.

28. Apparatus according to one of the foregoing apparatus claims, with means (6), for feeding the fibres to the glue-applying device in the form of a curtain or a mat, these means including rollers (6) and a conveyor belt or a weighing conveyor (1) being provided for delivering fibres to the rollers.

29. Apparatus according to one of the foregoing apparatus claims, with means (6) for feeding the fibres to the glue-applying device in the form of a curtain or a mat, these means including rollers (6), which are arranged one above another and offset, the rollers being arranged in particular so that they make an acute angle (α) with a conveyor belt or a weighing conveyor (1).

30. Apparatus according to one of the foregoing apparatus claims, with nozzles (8), in particular of conical shape, by which the glue is applied to the fibres or chips.

31. Apparatus according to one of the foregoing apparatus claims, with means by which glue together with heated air is applied to the fibres or chips.

32. Apparatus according to one of the foregoing apparatus claims, with means by which glue together with a hardener is applied to the fibres or chips.

33. Apparatus according to one of the foregoing apparatus claims, with a substantially vertically extending rising tube which follows on the glue-applying device and through which the fibres or chips are blown in a direction against gravity, means preferably being provided for cooling the walls of the rising tube.

34. Apparatus according to one of the foregoing apparatus claims, with a cyclone in which fibres or chips provided with glue are precipitated out, and/or an inspection station, at which the fibres or chips provided with glue can be optically monitored.

35. Apparatus according to one of the foregoing apparatus claims, with a press which has circulating pressing belts urged towards one another.

36. Apparatus according to one of the foregoing apparatus claims, with means for bringing fibres in the form of a curtain or a mat in front of the nozzles from which glue emerges.

37. Apparatus according to one of the foregoing apparatus claims, with a mixer (2) and an opening through which a curtain made up of fibres is introduced into or in front of the mixer, the opening corresponding to the maximum width of the mixer housing and the means for producing the curtain preferably being of dimensions such that the width of the curtain corresponds substantially to the width of the opening.

38. Apparatus according to one of the foregoing apparatus claims, in which a rising tube made of metal and/or a mixer made of metal is provided.

39. Apparatus according to one of the foregoing apparatus claims, in which means are provided for breaking down wood into solid and liquid components, and means for applying liquid components to the fibres or chips.

40. Board substantially comprising wood fibres and glue, in particular manufactured using apparatus according to one of the foregoing claims, characterised in that the proportion of glue in the board amounts to 45 to 55 kg per m³, in particular 50 to 52 kg per m³.
